(19) United States
(12) Patent Application Publication
(10) Pub. No.: US 2016/0103761 A1
(43) Pub. Date: Apr. 14, 2016

(54) SYSTEMS AND METHODS FOR PREPARING AN APPLICATION TESTING ENVIRONMENT AND FOR EXECUTING AN AUTOMATED TEST SCRIPT IN AN APPLICATION TESTING ENVIRONMENT

(71) Applicant: Toshiba Global Commerce Solutions Holdings Corporation, Tokyo (JP)

(72) Inventors: Anil Jain, Bangalore (IN); Prakash Krishnan, Bangalore (IN); Divya Padmanabha, Bangalore (IN)

(21) Appl. No.: 14/512,390

(22) Filed: Oct. 11, 2014

(51) Int. Cl. G06F 11/36; G06F 3/0482; G06F 3/0484

(52) U.S. Cl. CPC G06F 11/3696; G06F 11/3664; G06F 3/04842; G06F 3/0482

(57) ABSTRACT

Systems and methods for preparing an application testing environment and for executing an automated test script in an application testing environment are disclosed. According to an aspect, a method includes providing graphical user interface (GUI) test automation objects. The method also includes classifying each of the GUI test automation objects as one of a test essential object and a test navigation object. Further, the method includes serializing the GUI test automation objects classified as a test navigation object for subsequent testing in a testing environment.

### FIELD

Embodiments described herein relate to application testing. More particularly, embodiments described herein relate to preparation of an application testing environment and to execution of an automated test script in an application testing environment.

### BACKGROUND

Software testing is commonly utilized for providing information about the quality of a software product, service, or application under test. Test techniques include the execution of a program or application with the intent of finding software errors or other defects (often referred to as “software bugs”). Software testing typically involves the execution of one or more software components in a testing environment to evaluate one or more properties of interest. In general, these properties may indicate the extent to which the component or system under test meets requirements that guided its design and development, responds correctly to various inputs, performs its functions within an acceptable time, is sufficiently usable, can be installed and run in its intended environment, and achieves a desired result.

A particular type of software testing is GUI testing. Such testing involves testing a software component or system in a testing environment to ensure or determine whether it meets design and development requirements. This may typically be done through the use of various test cases. GUI testing and other types of testing can be a difficult task due, because software components and systems can include a large number of functions and code that need to be tested in a variety of different ways. For at least these reasons, it is desired to provide improved systems and techniques for software testing, particularly GUI testing.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 is a block diagram of an example system for preparing a testing environment and for executing an automated test script in the testing environment in accordance with embodiments of the present subject matter;

FIG. 2 is a flow chart of an example method for preparing a computing testing environment in accordance with embodiments of the present subject matter; and

FIG. 3 is a flow chart of an example method for executing an automated test script in the testing environment.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

As referred to herein, the term “serialization” refers to a process of translating data structures or objects into a format that can be stored and reconstructed subsequently in the same or another computing environment. For example, the serialized structure or object may be stored in memory, a file, a memory buffer, or transmitted across a network connection. When a serialized structure or object is reread according to the serialization format (or de-serialized), the de-serialized structures or objects may be used to create a semantically identical clone of the original structure or object.

As referred to herein, the term “test script” may refer to a set of instructions that are to be performed by an application or system under test to test that the application or system functions as expected. An example, manual testing is a process of manually testing software for defects. It requires a tester or user to play the role of an end user, and to use most of all features of the application to ensure correct behavior. In another example, test automation refers to the user of specialized software (apart from the application being tested) to control the execution of tests and the comparison of actual outcomes with predicted outcomes. Test automation can automate some repetitive but necessary tasks in a formalized testing process already in place, or add additional testing that may be difficult to perform manually.

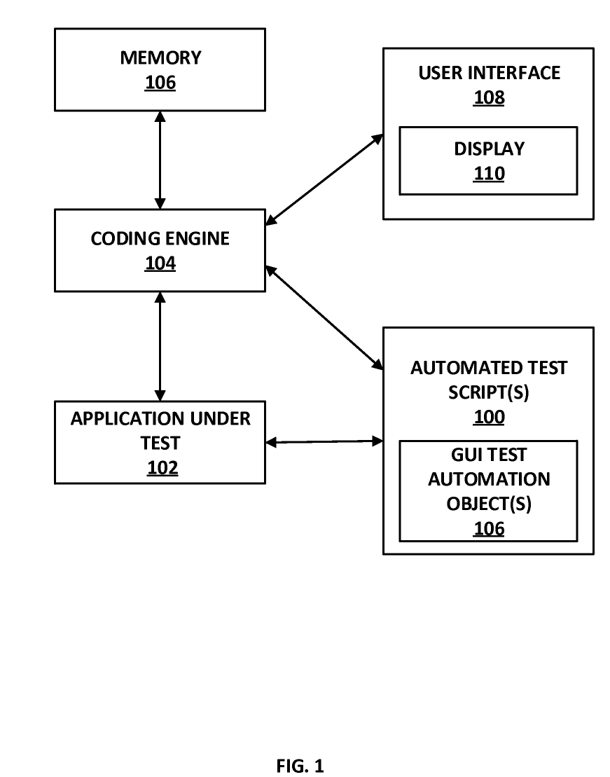

FIG. 1 illustrates a block diagram of an example system for preparing a testing environment and for executing an automated test script in the testing environment in accordance with embodiments of the present subject matter. The system shown in FIG. 1 can be a computing device configured to implement the various embodiments of the present subject matter. The system may include hardware, software, firmware, or combinations thereof for implementing embodiments of the present subject matter. For example, the system may include one or more processors and memory. It should be understood that the various embodiments of the present subject matter may be implemented by any other suitable system as will be understood by those of skill in the art.

Referring to FIG. 1, the example system includes one or more automated test scripts 100 for testing an application 102 in a testing environment. A test script 100 may include a set of instructions that is to be performed on the application 102. The testing can ensure that the application 102 is to perform as expected. The application 102 may be, for example, a retail sales application for shopping online or any other suitable application or system for undergoing testing. The test script 100 may be written, for example, using an automated functional GUI test tool (e.g., HP QuickTest Professional, Borland SilkTest, or Rational Robot) or in a suitable programming language (e.g., C++, C#, Tcl, Expect, Java, PHP, Perl, Powershell, Python, or Ruby). The test script may be configured, at least in part, for GUI testing of the application 102. For example, the GUI test script may involve generating user interface events, such as keystrokes and mouse clicks, for testing the application 102. The execution of the GUI test script on the application 102 in the testing environment may be associated with observation of input of the user interface events for validating that the observable behavior of the application 102 is correct.

Each test script 100 may include one or more GUI test automation objects 106. Each of the GUI test automation objects 106 may be classified as either a test navigation object or a test essential object in accordance with embodiments described herein. The classification can be performed by the use of a tagging mechanism via annotations specially designated for this purpose, by the scripter, based on a functional understanding of the Application Under Test. The annotation can in turn facilitate the serialization of the automation objects by the coding engine, that are tagged by the scripter to be de-serialized in the subsequent runs to not just test the automation object, but also its state, as recorded during the script creation, providing more accuracy to the test and also improving the speed of execution.

As referred to herein, the term “test navigation objects” may refer to objects which are not critical to testing result and used for the purpose of navigation for testing. The test navigational objects are not critical to testing result, but they are still required to execute the test. The term critical or required is used in the context of their contribution to the outcome of the test. As referred to herein, the term “test essential objects” may refer to objects which are used to conclude whether a test case has been executed or not. The objects that decide the failure or passing of a test can be tagged as essential. The same automation object can become essential for one test or navigational for another test based on the objective of the test.

In a particular example of testing retail sales application, the testing is performed using Credit card/Debit card/Gift card payment. If the objective of the test is to verify the order number generated, a credit card button may become navigational. Because it is just a step to generate the order, which is replaceable by taking an alternate option other than a credit card to place an order and complete the transaction. But if the objective of the test is to check the order number when credit card is used, the credit card button is an essential object to generate such order number.

In another example of testing retail sales application, a testing is performed to check the presence of 2 items added in the cart, and to ensure that each item has a delete link to remove from the cart. In such case, for example, searching items with typing into text box is navigational because the items can be added to the cart even without it. In the meanwhile, it is essential that verifying the delete links are working because the objective of the test is to find these delete links and remove items.

With continuing reference to FIG. 1, the system may include a coding engine 104 configured to classify the GUI test automation objects 106 as either a test navigation object or a test essential object. The coding engine 104 may perform object creation or generation for automation script execution.

The coding engine 104 may be configured to serialize the GUI test automation objects classified as a test navigation object for subsequent testing in the testing environment. Further, the coding engine 104 may store the serialized GUI test automation objects 106 at a predetermined location in a memory 106. The coding engine 104 may also identify the GUI test automation objects 106 classified as a test essential object as being classified as a test essential object. The coding engine 104 may also manage execution of the automated test scripts 100 for testing the application 102. Additional details of these functions and others are described in further detail herein. The coding engine 104 may implement a decision comparator that may initiate in a fail safe to use the object that is available at run time when the de-serialized object is not matching the navigation object. The objective may be to update the serialized object scheme to be used in subsequent testing runs.

Tags may be used in the subsequent tests to identify objects as either a test essential type or a test navigation type. These tags can be used by a suggested wrapper to determine whether a GUI test automation object has been serialized and saved at a predetermined location in memory, which can be a file or a database. Once the serialized objects have been updated or saved to the desired location, the subsequent testing runs can use the serialized objects at runtime by de-serialization without finding them each time at the application under test. As a result, resources at runtime can be saved in subsequent test runs.

In accordance with embodiments of the present subject matter, a wrapper can have a failsafe mechanism in place to re-discover and serialize any changes that may have taken place in navigation objects in case a failure occurs, such as an instance of an object not being found.

Objects marked as essential can be marked as “transient” so that they are not serialized and are always discovered at run time. This is such that a proper validation can be performed on these objects at each run to ensure an accurate result for each run.

The coding engine 104 may be include hardware, software, firmware, or combinations thereof configured to implement the functions described herein. For example, the coding engine 104 may include one or more processors and memory. The memory may include instructions for implementation by the process(s).

The system shown in FIG. 1 includes a user interface 108 configured to present graphics and information for preparing a testing environment and for executing an automated test script in the testing environment. For example, the user interface 108 may include a display 110 configured to display representations of GUI objects in a testing environment. The user interface 108 may be configured to receive user input for classifying GUI objects as either a GUI navigation object or a test essential object.

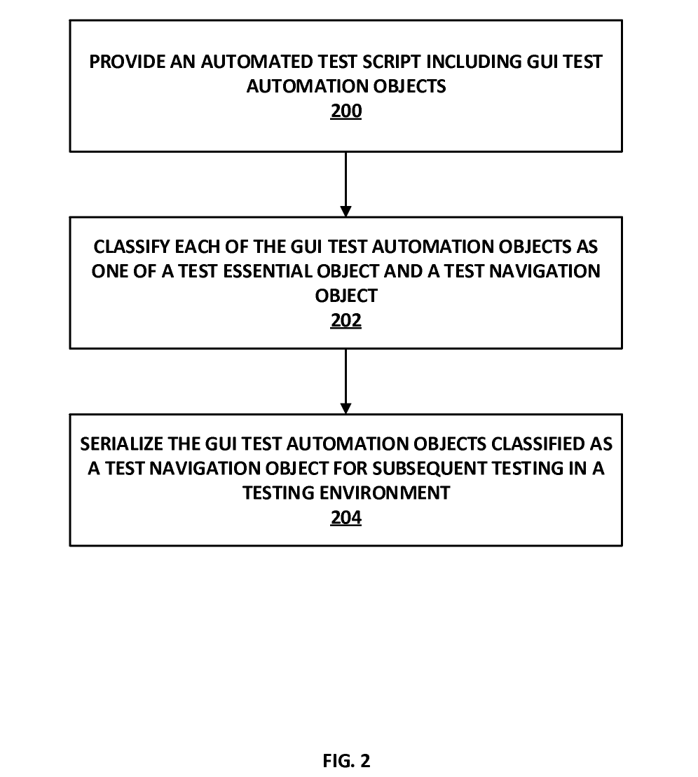

FIG. 2 illustrates a flow chart of an example method for preparing a computing testing environment in accordance with embodiments of the present subject matter. The method of FIG. 2 is described by example as being implemented by the system shown in FIG. 1, although it should be understood that the method may alternatively be implemented by any other suitable system or computing device.

Referring to FIG. 2, the method includes providing 200 an automated test script including multiple GUI test automation objects. For example, the coding engine 104 may be configured to suitably store one or more of the automated test scripts 100 in memory. The display 110 may display a menu of different test script 100 that may be applied to the application 102. The user may suitably interact with the user interface 108 to select one of the test scripts 100 for execution. Subsequently and in response to the selection, the coding engine 104 may initiate the selected test script 100.

The method of FIG. 2 includes classifying 202 each of the GUI test automation objects as one of a test essential object and a test navigation object. Continuing the aforementioned example, the user interface 108 may present representations of GUI test automation objects. As an example, the display 110 may, during execution of the test script, display representations of GUI test automation objects. The user may suitably enter input for classifying the GUI test automation objects 106 as either a test essential object or a test navigation object. The coding engine 104 may receive the user input and subsequently classify the GUI test automation objects 106 in accordance with the user's selections.

In a particular example of classifying GUI test automation objects, the application 102 may be a retail sales application including functionality for user login, for placing an order, and for validating a sales order number for the order. These functions may include the following sequence of actions and events: logging into the application by entering a user name and password, and “clicking” or otherwise selecting a displayed “go” or login button; selecting an “add item” button for an item to purchase; selecting a “complete order” button for initiating a purchase and complete order action; and validating an order number on a window or “pop up” graphic on the display 110. In this example, GUI test automation objects may be associated with these actions and events. The user name, password, login button (or “go” button), “add item” button, and “complete order” button may be classified as test navigation objects and can be tagged as “@navigation.” The window (or “pop up” graphic) for the new order can be classified as a test essential object and can be tagged as “@essential.”

The method of FIG. 2 includes serializing 204 the GUI test automation objects classified as a test navigation object for subsequent testing in a testing environment. Continuing the aforementioned example, the coding engine 104 may serialize the GUI test automation objects classified as a test navigation object for subsequent testing in the testing environment. The coding engine 104 may store serialized GUI test automation objects at a predetermined location in the memory 106. In the aforementioned example of classifying GUI test automation objects, the user name, password, login button (or “go” button), “add item” button, and “complete order” button can be serialized and stored in the memory 106, because they were classified as test navigation objects. In contrast, the window (or “pop up” graphic) for the new order is classified as a test essential object, and therefore the coding engine 104 would not serialize it with the expectation being that it would be rediscovered at run time by the automated test script 100 and used for logging the test case to be passed or failed.

The method of FIG. 2 can improve the execution of the test script 100 during subsequent runs of the test script on the application 102 under test. The improvement can result due to classifying GUI test automation objects as test essentials and test navigation and serializing in accordance with embodiments disclosed herein. As a result, the re-discovering of objects that are not critical to testing results can be prevented by saving and retrieving the test navigation objects from a serialized location in the memory 106, which may be referred to as an object schema. The resources used to re-discover the test navigation related to GUI automation objects can be saved as these objects can be used by the automated test script 100 to navigate through the application 102 with an aim of rendering the test essential objects for validation.

Once the test navigation objects that are serialized are de-serialized by the automated test script 100 at run time, they can be used during the entire duration of the automated test script 100 execution with an aim to navigate to the test essential object, which can be marked or otherwise identified as a non-serialized object and can be created at the execution time before the validation is performed.

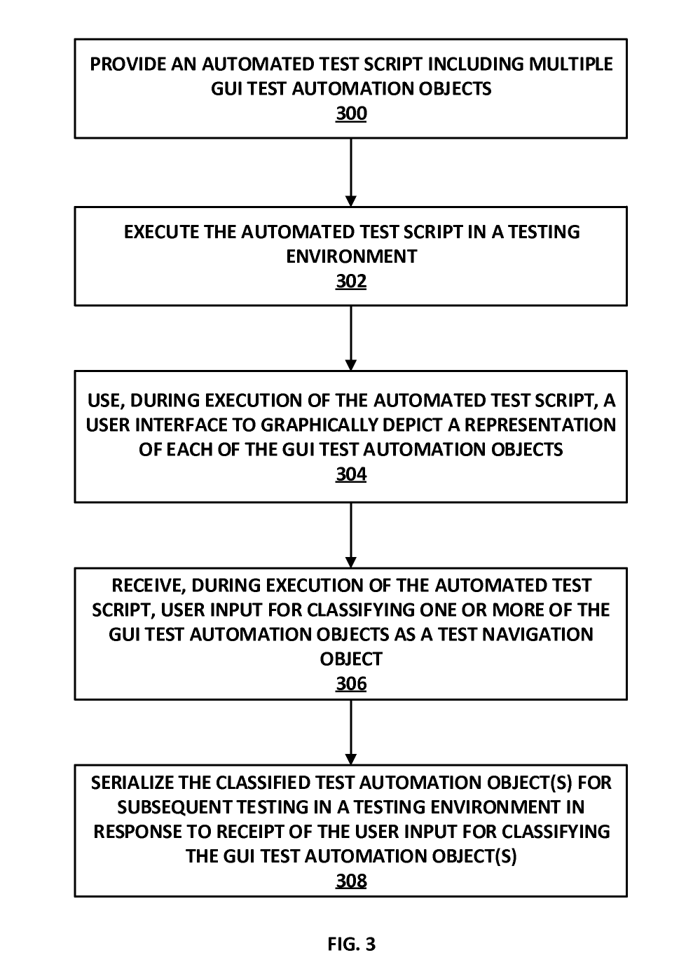

In accordance with embodiments of the present subject matter, FIG. 3 illustrates a flow chart of an example method for executing an automated test script in the testing environment. The method of FIG. 3 is described by example as being implemented by the system shown in FIG. 1, although it should be understood that the method may alternatively be implemented by any other suitable system or computing device.

Referring to FIG. 3, the method includes providing 300 an automated test script including multiple graphical user interface (GUI) test automation objects. For example, referring to FIG. 1, an automated test script 100 including multiple GUI test automation objects 106 may be provided in accordance with embodiments disclosed herein. Further, the method of FIG. 3 includes executing 302 the automated test script in a testing environment. For example, the coding engine 104 may execute the automated test script 100 for testing the application 102.

The method of FIG. 3 includes using 304, during execution of the automated test script, a user interface to graphically depict a representation of each of the GUI test automation objects. Continuing the aforementioned example, the user interface 108 may graphically present representations of GUI test automation objects 106 that are configured to be classified as either a test navigation object or a test essential object.

The method of FIG. 3 includes receiving 306, during execution of the automated test script, user input for classifying one or more of the GUI test automation objects as a test navigation object. Continuing the aforementioned example, the user may enter input for classification of the GUI test automation objects 106. The user input may be received by the coding engine 104.

The method of FIG. 3 includes serializing 308 the one or more classified GUI test automation objects for subsequent testing in a testing environment in response to receipt of the user input for classifying the one or more of the GUI test automation objects. Continuing the aforementioned example, the coding engine 104 may serialize the objects classified as being test navigation objects and store them in memory 106.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While certain embodiments have been described, these embodiments have been presented by way of example only, and are not intended to limit the scope of the inventions. Indeed, the novel methods, devices, and systems described herein may be embodied in a variety of other forms. Furthermore, various omissions, substitutions, and changes in the form of the methods, devices, and systems described herein may be made without departing from the spirit of the inventions. The accompanying claims and their equivalents are intended to cover such forms or modifications as would fall within the scope and spirit of the inventions.

What is claimed:

1. A method for preparing a testing environment, the method comprising:
using at least one processor and memory for:
providing a plurality of graphical user interface (GUI) test automation objects;
classifying each of the GUI test automation objects as one of a test essential object and a test navigation object; and
serializing the GUI test automation objects classified as a test navigation object for subsequent testing in a testing environment.

2. The method of claim 1, further comprising:
providing a user interface; and
using the user interface to receive user input that identifies one or more of the GUI test automation objects as a test navigation object, and
wherein classifying each of the GUI test automation objects comprises classifying the one or more identified GUI test automation objects based on the user input.

3. The method of claim 1, further comprising identifying the GUI test automation objects classified as a test navigation object as being classified as a test navigation object.

4. The method of claim 1, further comprising identifying the GUI test automation objects classified as a test essential object as being classified as a test essential object.

5. The method of claim 1, further comprising storing the serialized GUI test automation objects at a predetermined location in memory.

6. The method of claim 1, further comprising providing an automated test script including the GUI test automation objects.

7. The method of claim 6, further comprising executing the automated test script in the testing environment.

8. The method of claim 6, further comprising, during execution of the automated test script:
determining whether each of the GUI test automation objects is classified as a test navigation object; and
in response to determining that a GUI test object is classified as a test navigation object, de-serializing the GUI test automation object.

9. A method for executing an automated test script in the testing environment, the method comprising:
using at least one processor and memory for:
providing an automated test script including a plurality of graphical user interface (GUI) test automation objects;
executing the automated test script in a testing environment;
during execution of the automated test script:
using a user interface to graphically depict a representation of each of the GUI test automation objects; and
receiving user input for classifying one or more of the GUI test automation objects as a test navigation object; and
in response to receipt of the user input for classifying the one or more of the GUI test automation objects, serializing the one or more classified GUI test automation objects for subsequent testing in a testing environment.

10. The method of claim 9, wherein during execution of the automated test script the method further comprises:
receiving user input for classifying one or more of the GUI test automation objects as a test essential object; and
in response to receipt of the user input for classifying the one or more of the GUI test essential objects, classifying the one or more GUI test automation objects classified as a test essential object.

11. The method of claim 9, further comprising storing the one or more serialized GUI test automation objects at a predetermined location in memory.

12. The method of claim 9, wherein the user interface comprises a display, and
wherein using the user interface comprises using the display to display a plurality of GUI objects.

13. The method of claim 12, wherein receiving user input comprises receiving user input for tagging the GUI objects as test navigation objects.

14. The method of claim 9, wherein the user interface comprises a display, and
wherein using the user interface comprises using the display to display one or more GUI objects, and
wherein the method further comprises:
receiving user input receiving user input for tagging the one or more test essential objects as test essential objects; and
in response to receipt of the user input for tagging the one or more essential objects as test essential objects, classifying the one or more test essential objects classified as test essential objects.

15. A system for preparing a testing environment, the system comprising:
at least one processor and memory configured to:
provide a plurality of graphical user interface (GUI) test automation objects;
classify each of the GUI test automation objects as one of a test essential object and a test navigation object; and
serialize the GUI test automation objects classified as a test navigation object for subsequent testing in a testing environment.

16. The system of claim 15, further comprising a user interface, and
wherein the at least one processor and memory are configured to:
use the user interface to receive user input that identifies one or more of the GUI test automation objects as a test navigation object; and
classify the one or more identified GUI test automation objects based on the user input.

17. The system of claim 15, wherein the at least one processor and memory are configured to identify the GUI test automation objects classified as a test navigation object as being classified as a test navigation object.

18. The system of claim 15, wherein the at least one processor and memory are configured to identify the GUI test automation objects classified as a test essential object as being classified as a test essential object.

19. The system of claim 15, wherein the at least one processor and memory are configured to store the serialized GUI test automation objects at a predetermined location in memory.

20. The system of claim 15, wherein the at least one processor and memory are configured to:
execute an automated test script in the testing environment; and
during execution of the automated test script:
determine whether each of the GUI test automation objects is classified as a test navigation object; and
de-serialize the GUI test automation object in response to determining that a GUI test object is classified as a test navigation object.
